(19) United States
(12) Patent Application Publication
(10) Pub. No.: US 2007/0170093 A1
(43) Pub. Date: Jul. 26, 2007

(54) Hydrocarbon cracking catalyst and method for preparing the same

(76) Inventors: Sang-mun Jeong, Daejeon (KR); Won-ho Lee, Daejeon (KR); Jong-hyun Chae, Daejeon (KR); Jun-han Kang, Chungcheongnam-do (KR)

Correspondence Address: MCKENNA LONG & ALDRIDGE LLP, 1900 K STREET, NW, WASHINGTON, DC, 20006, US

(21) Appl. No.: 10/587,978

(22) PCT Filed: Apr. 19, 2005
(86) PCT No.: PCT/KR05/01120

§ 371 Date: Aug. 3, 2006

(30) Foreign Application Priority Data
Apr. 22, 2004 (KR) 10-2004-0027842

(51) Int. Cl. C10G 47/04; C10G 47/20; B01J 29/06

(52) U.S. Cl. 208/110; 502/63; 502/64; 502/71

(57) ABSTRACT

The present invention relates to a hydrocarbon cracking catalyst in which zeolite is fixed in the pores of metal oxide and a method for preparing the same. The method of the invention comprises the steps of a) vacuumi zing a container including metal oxide; b) adding zeolite powder in water and stirring it to obtain a slurry solution; c) spraying the slurry solution of step (b) into the vacuous container to penetrate it into the pores of the metal oxide support; and d) drying the catalyst prepared, in step (c) and calcining it to fix zeolite powder in the metal oxide support. The hydrocarbon cracking catalyst of the present invention can improve production yield of such olefins as ethylene and propylene and such aromatic compounds as BTX, reduce pressure drop inside the reactor without forming the zeolite catalyst and has superior rigidity.

### TECHNICAL FIELD

The present invention relates to a hydrocarbon cracking catalyst and a method for preparing the same. More particularly, the invention relates to a hydrocarbon cracking catalyst capable of improving production yield of such olefins as ethylene and propylene or such aromatic compounds as BTX from cracking of hydrocarbons in the presence of steam, offering good rigidity without zeolite forming or extrusion and reducing pressure drop inside the reactor and a method for preparing the same.

### BACKGROUND ART

Ethylene, propylene and BTX are important basic materials for petrochemical products. Typically, ethylene and propylene are prepared by cracking hydrocarbons mainly composed of such paraffinic compounds as natural gas, naphtha and gas oil in the presence of steam at a high temperature of at least 800° C. BTX is a byproduct obtained during this cracking process. In the steam cracking of hydrocarbons, it is required to increase hydrocarbon transition ratio or olefin selectivity to improve production yield of ethylene or propylene. Because increasing hydrocarbon transition ratio or olefin selectivity in steam cracking is limited, a variety of methods have been proposed to improve productivity of olefins.

Steam crackings using catalysts were proposed to improve production yield of ethylene and propylene in steam cracking of hydrocarbons. U.S. Pat. No. 3,644,557 disclosed a catalyst comprising magnesium oxide and zirconium oxide; U.S. Pat. No. 3,969,542 disclosed a catalyst comprising calcium aluminate as basic component; U.S. Pat. No. 4,111,793 disclosed a manganese oxide catalyst supported on zirconium oxide; Europe Patent Publication No. 0212320 disclosed an iron catalyst supported on magnesium oxide; and U.S. Pat. No. 5,600,051 disclosed a catalyst comprising bariumoxide, alumina and silica. However, because these catalysts require a high temperature for steam cracking of hydrocarbons, they tend to be severely coked.

U.S. Pat. No. 5,146,034 obtained olefins from paraffinic hydrocarbons in high yield by modifying a ZSM-5 zeolite toward group 1A. U.S. Pat. No. 5,968,342 also disclosed a method of preparing ethylene and propylene in high yield by adding an alkali earth metal ion to a ZSM-5zeolite. Besides, many patents refer to hydrocarbon cracking catalysts based on zeolite catalysts. When zeolite is used instead of metal oxide, such aromatic compounds as BTX are obtained in good yield, as well as olefins. Also, the zeolite-based hydrocarbon cracking catalysts are advantageous in that they require lower temperature for cracking than the oxide catalysts. On the other hand, they have so high an acidity that cokes tend to be deposited on the surface of the catalyst, thereby inactivating the catalyst rapidly.

Korea Patent No. 1996-7002860 disclosed a method of preparing a zeolite catalyst in which alumina is bound. The zeolite used in the catalyst was zeolite Y. The catalyst was prepared by grinding the zeolite along with water and alumina and extruding the mixture.

Hydrocarbon cracking at high temperature causes severe cokes generation. Although steam is used as diluent to remove the cokes, coking is still severe and the cokes cause many problems, as deposited on the wall of the reactor or so. Accordingly, reducing the temperature of the hydrocarbon cracking reaction seems the most practical way of reducing cokes generation. Here, using a catalyst is the most practical way of obtaining adequate hydrocarbon transition ratio and olefin productivity.

### DISCLOSURE OF INVENTION

It is an object of the present invention to provide a hydrocarbon cracking catalyst capable of improving production yield in preparing such olefins as ethylene and propylene or such aromatic compounds as BTX from cracking of hydrocarbons, compared with conventional metal oxide catalysts, offering superior catalyst rigidity without forming or extrusion processes required in manufacturing of conventional zeolite catalysts and reducing pressure drop inside the reactor and a method for preparing the same.

The aforementioned object and other objects can be attained by the present invention, as described below.

To attain the object, the present invention provides a hydrocarbon cracking catalyst in which zeolite is fixed in the pore of metal oxide.

The invention also provides a method of preparing a hydrocarbon cracking catalyst comprising the steps of:

a) vacuumizing a container including metal oxide;

b) adding zeolite powder in water and stirring it to obtain a slurry solution;

c) spraying the slurry solution of step (b) into the vacuous container to penetrate it into the pores of the metal oxide support; and

d) drying the catalyst prepared in step (c) and baking it to fix zeolite powder in the metal oxide support.

The metal oxide may be selected from the group consisting of α-alumina, silica, silica-alumina, zirconium oxide, magnesium oxide, magnesium aluminate and calcium aluminate.

The zeolite may have an MFI, MEL, TPN, MTT or FER structure.

The zeolite may be an HZSM-5 catalyst or a catalyst in which a metal constituent is ion-exchanged or impregnated in HZSM-5.

The zeolite may be comprised in 0.1-30 wt % per 100 wt % of the metal oxide support.

The hydrocarbon may be a C₄-C₈ paraffinic or olefin hydrocarbon.

The metal oxide may have a shape selected from the group consisting of a sphere, a Raschig ring and a Leschig ring.

Hereunder is given a more detailed description of the present invention.

The present invention intends to improve production yield of olefins and BTX by locating the zeolite catalyst, which induces hydrocarbon cracking at low temperature, inside the pores of such metal oxide support as alumina, silica-alumina or zirconia, thereby and reduce pressure drop inside the reactor by varying the shape of the catalyst.

In locating the zeolite inside the metal oxide support, the present invention applies the principle of vacuum. The method of the invention comprises the steps of:

a) vacuumizing a container including metal oxide;

b) adding zeolite powder in water and stirring it to obtain a slurry solution;

c) spraying the slurry solution of step (b) into the vacuous container to penetrate it into the pores of the metal oxide support; and

d) drying the catalyst prepared in step (c) and baking it to fix zeolite powder in the metal oxide support.

The hydrocarbon cracking catalyst prepared by the invention has advantageous over conventional metal oxide catalysts in that it can significantly reduce reaction temperature of hydrocarbon cracking and greatly improve production yield of olefin at the same reaction temperature. Also, it can remove the inconvenience of adding binder to adequately form the zeolite powder. When hydrocarbon cracking is performed in the presence of a zeolite catalyst, a circulating fluidized bed reactor is usually preferred because of the problem related with zeolite forming, particularly catalyst rigidity, pressure drop inside the reactor inactivation of the catalyst due to cokes. However, when the catalyst presented by the present invention is used, it possible to use a fixed bed reactor if fine zeolite particles are fixed in the pores of the metal oxide support having the shape of a Raschig ring in order to reduce pressure drop inside the reactor. Also, it is not necessary to further form the fine zeoliteparticles. In addition, such metal oxides as α-alumina, silica-alumina and zirconia have much superior rigidity to zeolite.

In the conventional hydrocarbon cracking, such reactants as natural gas, naphtha and gas oil are cracked with steam at a high temperature of at least 800° C. in the absence of a catalyst to obtain ethylene, propylene, etc.

The present inventors found out that when a ZSM-5 zeolite fixed in the pores of a metal oxide having macropores is used in cracking, reaction temperature can be lowered than that of the conventional steam cracking and production yields of olefins and aromatic compounds such as BTX can be improved. Also, while the conventional hydrocarbon crackings using zeolite-based catalysts had to use FCC type circulating fluidized bed reactors because of deactivation of the catalyst by the cokes generated during the reaction, the catalyst of the present invention enables hydrocarbon cracking using fixed bed reactors by fixing the zeolite catalyst formed into such a shape as Raschig ring, which is well known to the one in the art as minimizing pressure drop inside the reactor, in the pores of a metal oxide having superior rigidity such as alumina, silica-alumina and zirconia.

In order to convert hydrocarbons to valuable petrochemical products, researches on cracking hydrocarbons in the presence of zeolite-based catalysts and producing olefins and aromatic hydrocarbons are being performed. In general, when a zeolite-based catalyst such as ZSM-5 is used to crack hydrocarbons, low alkanes such as methane, ethane and propane, low alkenes such as ethylene and propylene and aromatic compounds are produced.

A zeolite is a crystalline, microporous molecular sieve comprising latticed silica and alumina bound with exchangeable cations like alkali or alkali earth metal ions. Commonly, a synthetic zeolite is prepared by crystallizing the zeolite from a supersaturated synthetic mixture. The resultant crystal is dried and baked to obtain zeolite powder. Reactivity of the obtained zeolite can be changed significantly by replacing the cations with metal ions, impregnating metals in the pores of the zeolite or adjusting the concentration of alumina in the lattice.

The catalyst of the present invention includes medium-pore-sized zeolites, which are used as active site in hydrocarbon cracking, having an average pore size of about 5-7 Å and an SiO₂/Al₂O₃ ratio of at least 10, which may have such crystalline structure as MFI, MEL, TPN, MTT and FER. Most preferably, the molecular sieve of the present invention is ZSM-5. ZSM-5 includes alkali or alkali earth metal cations. HZSM-5, which is prepared by ion exchange with ammonium cations and calcined at 300-600° C. by the method well known in the art, is the most preferred as catalyst of the present invention. Also, metal constituents can be replaced by impregnation or ion exchange.

Preferably, the zeolite is fixed in 0.1-30 wt % per 100 wt % of the metal oxide support. If the zeolite content is below 0.1 wt %, the catalytic activity is low. Otherwise, if it exceeds 30 wt %, the zeolite covers the surface as well as the pores of the metal oxide, thereby greatly increasing the coking rate. The metal oxide support may be any common support such as α-alumina, silica, silica-alumina, zirconium oxide, magnesium oxide, magnesium aluminate and calcium aluminate. More preferably, a support having a surface area of at most 1 m²/g is used.

The process of preparing the catalyst of the invention is as follows.

First, metal oxide support such as α-alumina, silica, silica-alumina, zirconium oxide, magnesium oxide, magnesium aluminate and calcium aluminate of a wanted amount is put in a container. Then, the container is vacuumized using a vacuum pump. Microporous zeolite, particularly ZSM-5, of a wanted amount is prepared in to a slurry solution. The solution is stirred for at least 6 hours, so that the zeolite particles are uniformly mixed in the slurry solution. The slurry solution at normal pressure is sprayed through a tube, pipe, nozzle, etc. to the porous metal oxide support, so that the ZSM-5 slurry solution permeates into the pores of the metal oxide. The catalyst is taken out, dried in an oven and calcined in a furnace of about 400-800° C. for at lest 1 hour to obtain a metal oxide catalyst wherein ZSM-5 is fixed.

In applying the hydrocarbon cracking catalyst to cracking, such reactors as a fixed bed reactor, fluidized bed reactor, moving bed reactor, etc. may be used. In general, in the repetitive process with short catalyst recycling cycles using a fluidized bed reactor or a moving bed reactor, production yield of ethylene or propylene can be improved by increasing transition ratio of hydrocarbon, if α-alumina itself is used as catalyst. It is because the catalyst particles act as heat transfer medium. Especially, if the zeolite catalyst constituent of the present invention is fixed in metal oxide, the resultant catalyst can not only reduce the cracking temperature but also increase production yield of olefins.

In case hydrocarbon cracking is performed in a fixed bed reactor, it is possible to form the metal oxide support such as α-alumina into the shape of a sphere or pellet. But, if so, there may be a large pressure gradient in the catalyst layer. To solve this problem, it is preferable to form the support into the shape of a Raschig ring or other special geometry, so that the porosity of the catalyst layer is maximized, and fix the zeolite in the pores of the metal oxide.

The catalyst of the present invention is advantageous in that it improves production yield of ethylene and propylene, compared with the conventional steam cracking, and reduce reaction temperature. Because steam cracking of hydrocarbon is performed at a high temperature of at least 830° C., the cokes deposited on the surface of the reaction tube interferes with heat transfer. To compensate for this loss, the reaction tube should be heated to a higher temperature, which further increases energy loss. On the contrary, when the catalyst of the invention is used, hydrocarbon cracking is performed at 650° C. or so, thereby significantly reducing deposition of the catalyst on the surface of the reaction tube. Also, because the catalyst of the invention has superior rigidity and the catalytic zeolite constituent can be easily fixed in the metal oxide support having a special shape that can avoid pressure drop without using a binder, it is possible to reduce pressure drop at the surface of the catalyst caused by cokes.

### BRIEF DESCRIPTION OF DRAWINGS

FIG. 1 is a photograph showing the inner pores of metal oxide. It shows HZSM-5 fixed in the pores of the metal oxide.

### MODES FOR CARRYING OUT THE INVENTION

Hereinafter, the present invention is described in more detail through examples. However, the following examples are only for the understanding of the present invention and they do not limit the invention.

### EXAMPLE 1

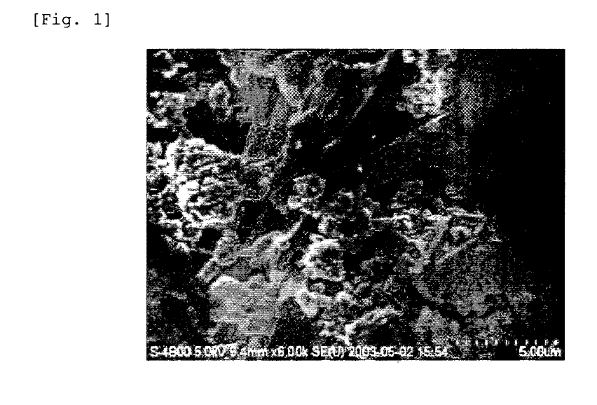

100 g of pure silica-alumina support contained in a round flask was put in a vacuum rotary drier. The flask was slowly rotated while keeping it a vacuum of 100 mbar or below. HZSM-5 (SiO₂/Al₂O₃ ratio=30) powder was used for the ZSM-5 to be fixed in the silica-alumina support. 4 g of HZSM-5 was added to 23 mL of distilled water and was stirred to obtain a slurry solution in order to fix 4 wt % of HZSM-5 per 100 wt % of the silica-alumina support. The resultant slurry solution was sprayed into the flask containing the support through a nozzle, so that it penetrated into the pores of the silica-alumina. The slurry solution was dried in the vacuum rotary drier and baked in a baking furnace of 600° C. for 4 hours to obtain a macroporous HZSM-5 catalyst fixed in the silica-alumina support. FIG. 1 shows the inner pores of the prepared catalyst. As seen in the figure, fine HZSM-5 powders are stably fixed in the silica-alumina support.

The catalyst was filled in a quartz tube having an outer diameter of ½″ to a height of 10 cm. Keeping the reaction temperature at 650° C., n-butane and nitrogen were fed to the reactor, at a rate of 4.1 mL/min and 9.3 mL/min, respectively. Cracking product coming out of the reactor was quantitatively analyzed with gas chromatography. Table 1 below shows the modification result for n-butane.

Yield of the product was calculated by Equation 1 below.
Yield of product (wt %)=(Weight of product)/(Weight of supplied butane)×100 [Equation 1]

### EXAMPLE 2

The process of Example 1 was repeated, except that 10 g of HZSM-5 was added to 23 mL of distilled water and stirred to prepare a slurry solution in order to fix 10 wt % of HZSM-5 in 100 wt % of the silica-alumina support. Table 1 shows the modification result for n-butane.

### EXAMPLE 3

The process of Example 1 was repeated, except that 25 g of HZSM-5 was added to 23 mL of distilled water and stirred to prepare a slurry solution in order to fix 25 wt % of HZSM-5 in 100 wt % of the silica-alumina support. Table 1 shows the modification result for n-butane.

### COMPARATIVE EXAMPLE 1

Cracking of n-butane was performed using pure silica-alumina as catalyst. The silica-alumina used was a spherical one having a diameter of 5 mm, a surface area of 0.04 m²/g, a porosity of 21.89% and an average pore diameter of 19.76 μm. The silica-alumina was filled in a quartz tube having an outer diameter of ½″ to a height of 10 cm. Keeping the reaction temperature at 650° C., n-butane and nitrogen were fed to the reactor, at a rate of 4.1 mL/min and 9.3 mL/min, respectively. Cracking product coming out of the reactor was quantitatively analyzed with gas chromatography. Table 1 shows the modification result for n-butane.

### COMPARATIVE EXAMPLE 2

Cracking of n-butane was performed using a pure HZSM-5 (SiO₂/Al₂O₃ ratio=30) catalyst. 0.5 g of the HZSM-5 catalyst was filled in a quartz tube having an outer diameter of ½″. Keeping the reaction temperature at 650° C., n-butane and nitrogen 5 were fed to the reactor, at a rate of 4.1 mL/min and 9.3 mL/min, respectively. Cracking product coming out of the reactor was quantitatively analyzed with gas chromatography. Table 1 shows the modification result for n-butane.

TABLE 1

| | | | | Comparative | Comparative |
|---|---|---|---|---|---|
| Category | Example 1 | Example 2 | Example 3 | Example 1 | Example 2 |
| Catalyst | 4 wt % HZSM-5/ | 10 wt % HZSM-5/ | 25 wt % HZSM-5/ | Silica-alumina | HZSM-5 |
| | silica-alumina | silica-alumina | silica-alumina | | |
| Reaction | 650 | 650 | 650 | 650 | 650 |
| temperature (° C.) | | | | | |
| Yield of | 22.6 | 10.6 | 10.3 | 10.5 | 14.3 |
| ethylene (wt %) | | | | | |
| Yield of | 14.8 | 3.7 | 3.0 | 16.2 | 3.3 |
| propylene (wt %) | | | | | |
| Yield of BTX (wt %) | 18.6 | 46.9 | 48.3 | 0 | 41 |

As seen in Table 1, when n-butane was cracked using only silica-alumina as catalyst, as in Comparative Example 1, at the same reaction temperature (650° C.) of Examples, yield of ethylene and propylene was about 17% in total and BTX, an important product, was not detected. When only HZSM-5 was used as in Comparative Example 2, yield of propylene decreased significantly, whereas that of BTX increased to 41%. When 4 wt % HZSM-5/silica-alumina was used as catalyst (Example 1), yields of ethylene and propylene increased greatly and the yield of BTX reached 19%. When the content of HZSM-5 was increased further (Example 2), production of BTX was significantly promoted. When 25 wt % of HZSM-5 was used (Example 3), the result was almost the same as when 10 wt % of HZSM-5 was used. In the present invention, nitrogen was used as diluent gas. However, steam can be used instead of nitrogen. Also, nitrogen and steam can be used simultaneously. Also, it is possible to add other metal constituents to the HZSM-5 catalyst by ion exchange or impregnation, in order to improve yield of olefins or BTX.

Table 1 shows that the present invention can significantly improve the yield of olefins and BTX, compared with when only the silica-alumina support is used. Also, the present invention is advantageous in that, differently from when only the HZSM-5 catalyst is used, production yield can be controlled by adjusting the content of HZSM-5fixed in the support. Besides, the catalyst has much superior rigidity to that of HZSM-5, because the HZSM-5 is fixed in silica-alumina having very superior rigidity. If a support having a special shape such as a Raschig ring is used, pressure drop inside the reactor can be greatly reduced during hydrocarbon cracking, which makes it possible to replace the conventional fluidized bed process with a fixed bed process.

### INDUSTRIAL APPLICABILITY

As described above, the hydrocarbon cracking catalyst of the present invention can improve production yield of such olefins as ethylene and propylene and such aromatic compounds as BTX even at a lower reaction temperature than that of the conventional hydrocarbon cracking process using metal oxide catalysts. Because the reaction temperature can be significantly reduced compared with the conventional steam cracking, energy consumption can be reduced and cokes generated on the wall of the reactor can be decreased greatly. When a zeolite catalyst is used, a forming process using a binder is required. On the other hand, the catalyst of the present invention has superior rigidity even without the forming process. Also, because pressure drop inside the reactor can be reduced, the hydrocarbon cracking process can be performed with a fixed bed type reactor, as well as a fluidized bed reactor.

While the present invention has been described in detail with reference to the preferred embodiments, those skilled in the art will appreciate that various modifications and substitutions can be made thereto without departing from the spirit and scope of the invention as set forth in the appended claims.

What is claimed is:

1. A hydrocarbon cracking catalyst in which zeolite is fixed in the pores of a metal oxide support.

2. The hydrocarbon cracking catalyst of claim 1, wherein the zeolite is comprised in 0.1-30 wt % per 100 wt % of the metal oxide support.

3. The hydrocarbon cracking catalyst of claim 1, which is used to crack C₄-C₈ paraffinic or olefinic hydrocarbons.

4. The hydrocarbon cracking catalyst of claim 1, wherein the metal oxide has a shape selected from the group consisting of a sphere, a Raschig ring and a Leschig ring.

5. The hydrocarbon cracking catalyst of claim 1, wherein the metal oxide is selected from the group consisting of α-alumina, silica, silica-alumina, zirconium oxide, magnesium oxide, magnesium aluminate and calcium aluminate.

6. The hydrocarbon cracking catalyst of claim 1, wherein the zeolite has a structure of MFI, MEL, TPN, MTT or FER.

7. The hydrocarbon cracking catalyst of claim 1, wherein the zeolite is a HZSM-5 catalyst or a catalyst in which metal constituents are ion-exchanged or impregnated in HZSM-5.

8. A method for preparing a hydrocarbon cracking catalyst comprising the steps of:
a) vacuumizing a container including metal oxide;
b) adding zeolite powder in water and stirring it to obtain a slurry solution;
c) spraying the slurry solution of step (b) into the vacuous container to penetrate it into the pores of the metal oxide support; and
d) drying the catalyst prepared in step (c) and calcining it to fix zeolite powder in the metal oxide support.

9. The method of claim 8, which is applied to C₄-C₈ paraffinic or olefinic hydrocarbons.

10. The method of claim 8, wherein the metal oxide has a shape selected from the group consisting of a sphere, a Raschig ring and a Leschig ring.

11. The method of claim 8, wherein the metal oxide is selected from the group consisting of α-alumina, silica, silica-alumina, zirconium oxide, magnesium oxide, magnesium aluminate and calcium aluminate.

12. The method of claim 8, wherein the zeolite has a structure of MFI, MEL, TPN, MTT or FER.

13. The method of claim 8, wherein the zeolite is a HZSM-5 catalyst or a catalyst in which metal constituents are ion-exchanged or impregnated in HZSM-5.

14. The method of claim 8, wherein the zeolite is comprised in 0.1-30 wt % per 100 wt % of the metal oxide support.
